(19) United States
(12) Patent Application Publication
(10) Pub. No.: US 2025/0337202 A1
(43) Pub. Date: Oct. 30, 2025

(54) POWER STRIP

(71) Applicant: Eric W Kramer, Laguna Beach, CA (US)

(72) Inventor: Eric W Kramer, Laguna Beach, CA (US)

(21) Appl. No.: 18/645,200

(22) Filed: Apr. 24, 2024

(51) Int. Cl. H01R 13/72; H01R 25/00

(52) U.S. Cl. CPC H01R 13/72; H01R 25/003

(57) ABSTRACT

The present invention is a power strip, in particular, a power strip with seven outlets with a reduced form factor for improved shipping and/or storage. The power strip comprises a power cord with an input plug and a top surface and a bottom surface separated by a body portion with a perimeter and four corners. The top surface has at least seven power outlets. The perimeter has a storage outlet with added resistance for the input plug when inserted when the power strip is in a storage configuration. The top surface and the bottom surface extend beyond the four corners of the body portion such that the power cord is wrapped twice around the perimeter when the power strip is in the storage configuration. The power strip has a housing volume less than 500 cm3.

### TECHNICAL FIELD

The present invention is a power strip, in particular, a power strip with seven outlets with a reduced form factor for improved shipping and/or storage.

### BACKGROUND ART

Power strips that offer at least seven outlets and surge protection in a traditional form factor can present issues regarding shipping and storage of the devices. Thus, a power strip with a reduced form factor that improves shipping and storage without a reduction in the number of outlets is needed.

### SUMMARY OF THE INVENTION

The present invention is a power strip, in particular, a power strip with seven outlets with a reduced form factor for improved shipping and/or storage. The power strip comprises a power cord with an input plug and a top surface and a bottom surface separated by a body portion with a perimeter and four corners. The top surface has at least seven power outlets. The perimeter has a storage outlet with added resistance for the input plug when inserted when the power strip is in a storage configuration. The top surface and the bottom surface extend beyond the four corners of the body portion such that the power cord is wrapped twice around the perimeter when the power strip is in the storage configuration. The power strip has a housing volume less than 500 cm3.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a perspective view of a preferred embodiment of the invention in a storage configuration;

FIG. 2 is a perspective view of the preferred embodiment of the invention in a deployed configuration;

FIG. 3A is a top view of the preferred embodiment of the invention;

FIG. 3B is a side view of the preferred embodiment of the invention; and,

FIG. 4 is a perspective view of the preferred embodiment of the invention.

### DETAILED DESCRIPTION OF THE PREFERRED EMBODIMENTS

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s). The following description is provided to enable any person skilled in the art to make and use the invention and sets forth the best modes contemplated by the inventors of carrying out their invention. Various modifications, however, will remain readily apparent to those skilled in the art since the general principles of the present invention have been defined herein specifically to provide a variable control switch.

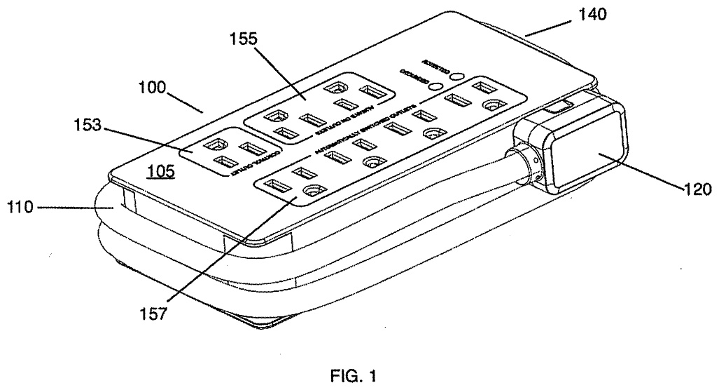

Referring now to FIG. 1, a perspective view of a preferred embodiment of the invention is shown, namely a power strip, in particular, a power strip with seven outlets with a reduced form factor for improved shipping and/or storage. The power strip 100 is shown in a storage configuration with a body portion 105 and a power cord 110 wrapped around the body portion 105 with an input plug 120 inserted into a storage outlet 130 (not visible). The power strip 100 has a top surface 140 with, preferably, seven outlets. The seven outlets preferably comprise two (2) “always on” outlets 155, four (4) “automatically switched” or “controlled” outlets 157 and one (1) “control” outlet 153. The top surface 140 of the power strip 100 also preferably has a “grounded” indicator light 160 and a “protected” indicator light 165. The grounded indicator light 160 preferably indicates when the power strip 100 is connected to a grounded electrical circuit. The protected indicator light 165 preferably indicates that the device has surge protection active and working, preferably from at least one metal oxide varister (MOV) (not shown). The preferred embodiment preferably comprises a 15 amp circuit breaker.

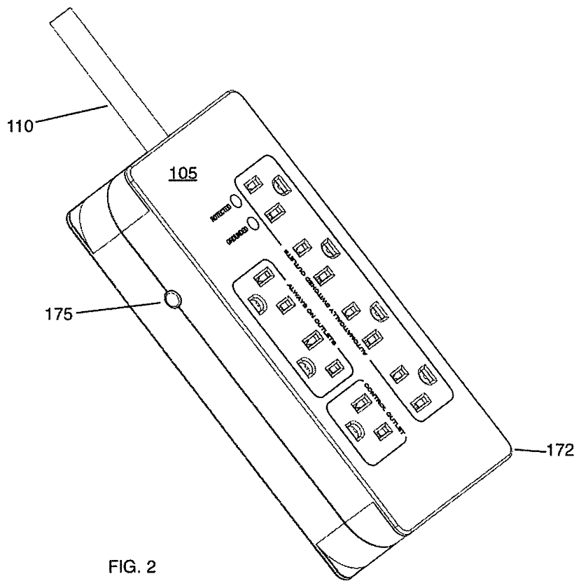

Referring now to FIG. 2, a perspective view of a preferred embodiment of the invention is shown in a deployed configuration. In particular, the power cord 110 extends from the body portion 105. The power cord 110 can be inserted into a standard electrical socket (not shown) to supply power to the power strip 100. The body portion 105 preferably is rectangular. The body portion 105 preferably has rounded corners 172 where the top surface 140 and a bottom surface 145 preferably extend outward from the body portion 105 at the rounded corners 172 to make space for the power cord 110 when the power strip 100 is in the storage configuration. Preferably, the power cord 110 can be wrapped twice around the recessed perimeter 170 when the power strip is in storage configuration. A reset button 175 is preferably located on the recessed perimeter 170 that permits a user to reset the power strip 100 after a power surge.

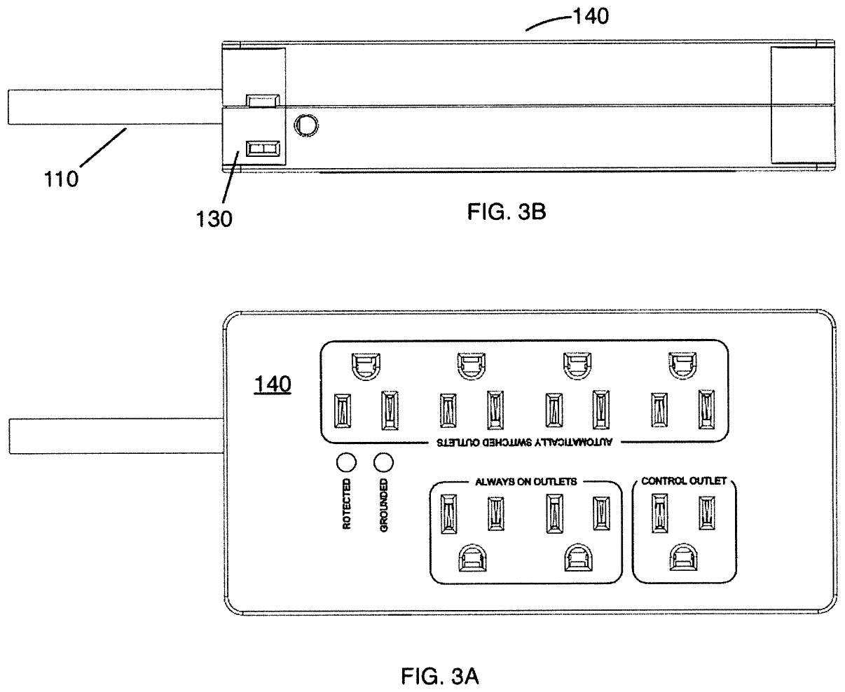

Referring now to FIG. 3A, a top view of the preferred embodiment of the power strip 100 is shown. Referring next to FIG. 3B, a side view of the third embodiment of the power strip 100 is shown. In particular, the storage outlet 130 is visible. The storage outlet 130 preferably is unpowered when the power cord 110 is connected to an electrical socket. Instead, the input plug 120 can be plugged into the storage outlet 130 when the power strip 100 is in a storage configuration to hold the power cord 110 and input plug 120 in place around the body portion 105 and corners 172. The storage outlet 130 preferably provides added resistance to hold the input plug 120 in place in comparison to resistance offered by a standard electrical socket.

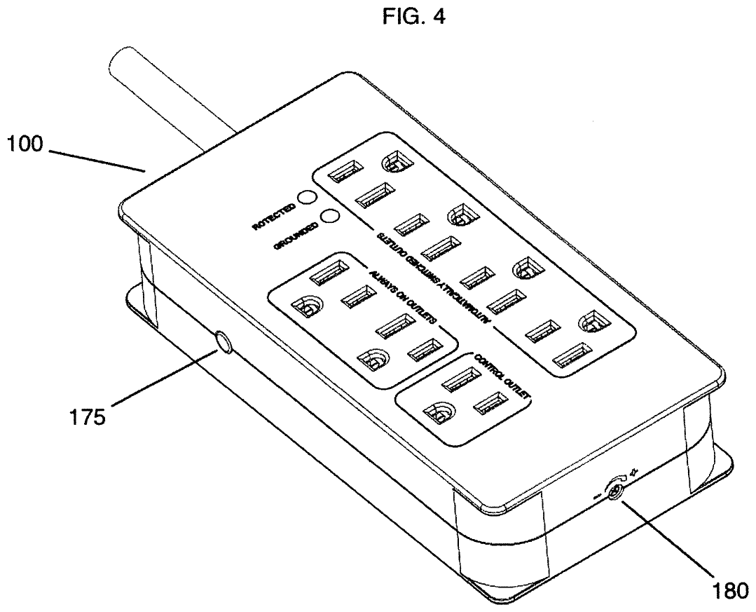

Referring now to FIG. 4, a perspective top view of the preferred embodiment is shown. In particular, the power strip 100 preferably has an adjustment screw 180 that can adjust an actuation threshold for controlling a device's current draw when under power. For example, a television might draw current while in sleep mode. The control outlet 153 is preferably controlled by the adjustment screw 180. For example, when power to the control outlet 153 exceeds the adjusted actuation threshold, the controlled outlets 157 switch on.

Accordingly, the present invention provides an improved configuration for storage and/or shipping of the device. For example, the preferred embodiment of the device combined with packaging matches the height of most A19 bulb packages, which is generally useful in assembling and shipping kits of energy-saving products, which often includes A19 bulbs. The preferred embodiment of the device is 6.5″ in length, 3.25″ in width and has a thickness of 1^{3/8}″ and has a volume of 29.05 cubic inches (in³). When combined with a 3-foot power cord, this allows for packaging under 60 cubic inches. Conversely, prior art power strips with seven or more outlets range in housing volume from 57.85 in³ (948 cm³) to 122.90 in³ (2014 cm³) whereas a preferred embodiment of the present invention has a housing volume of 29.05 in³ (476 cm³). Alternately, prior art power strips might have a reduced number of outlets to reduce overall volume. Prior art power strips range in volume per outlet from 4.88 in³ (80 cm³)/outlet to 16.05 in³ (263.05 cm³)/outlet. The preferred embodiment of the present invention has a volume per outlet of 4.29 in³ (70.29 cm³)/outlet ratio. Moreover, when packaged, the preferred embodiment of the present invention has a volume of 56.69 in³ (929 cm³) while prior art packaged power strips are not less than 61.02 in³ (1,000 cm³).

Thus, a power strip with an improved storage configuration is described above. In each of the above embodiments, the different positions and structures of the present invention are described separately in each of the embodiments. However, it is the full intention of the inventor of the present invention that the separate aspects of each embodiment described herein may be combined with the other embodiments described herein. Those skilled in the art will appreciate that adaptations and modifications of the just-described preferred embodiment can be configured without departing from the scope and spirit of the invention. Therefore, it is to be understood that, within the scope of the appended claims, the invention may be practiced other than as specifically described herein.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A power strip comprising, a power cord with an input plug, a top surface and a bottom surface separated by a body portion with a perimeter and four corners;
the top surface further comprising at least seven power outlets;
the perimeter further comprising a storage outlet; and,
where the top surface and the bottom surface extend beyond the four corners of the body portion such that the power cord is wrapped around the perimeter at the four corners when the power strip is in a storage configuration.

2. The power strip of claim 1 where the power cord is wrapped twice around the perimeter when the power strip is in a storage configuration.

3. The power strip of claim 1 where the power strip further comprises an adjustment screw for adjustment of an actuation threshold.

4. The power strip of claim 1 where the top surface has a width of 3.25 inches.

5. The power strip of claim 1 where the storage outlet is unpowered when the power cord is connected to an electrical socket.

6. The power strip of claim 1 where the power strip has a housing volume less than 500 cm3.

7. The power strip of claim 1 where the storage outlet has an added resistance for insertion of the input plug.
